(19) United States
(12) Patent Application Publication
(10) Pub. No.: US 2017/0027363 A1
(43) Pub. Date: Feb. 2, 2017

(54) PEELER

(71) Applicant: MOHA Moderne Haushaltwaren AG, Vernier (CH)

(72) Inventor: Ulrich GREINER, Neu-Ulm (DE)

(73) Assignee: MOHA Moderne Haushaltwaren AG, Vernier (CH)

(21) Appl. No.: 15/220,722

(22) Filed: Jul. 27, 2016

(30) Foreign Application Priority Data
Jul. 28, 2015 (CH) 01095/15

(51) Int. Cl. A47J 17/02

(52) U.S. Cl. CPC A47J 17/02

(57) ABSTRACT

A peeler has a handle and a blade holder disposed on the grip head of the handle with an adjustable pendulum blade. The pendulum blade is disposed adjustably by an angle between a blade pendulum axis direction and a grip longitudinal axis direction of the handle. The blade holder is configured to be substantially semi-circular and is provided with a blade holder profile moulding disposed on the outer circumference of the blade holder. Furthermore, a grip head profile moulding complementary to the blade holder profile moulding is provided on the grip head, in such a manner that the blade holder profile moulding and the grip head profile moulding engage displaceably and positionably in one another in order to achieve a smooth adjustability of the blade holder on the handle for adjustment of the angle.

### TECHNICAL FIELD

The disclosure relates to a peeler having a handle and a blade holder disposed on the grip head of the handle with an adjustable pendulum blade, wherein the pendulum blade is disposed adjustably about an angle between a blade pendulum axis direction and a grip longitudinal axis direction of the handle.

### BACKGROUND ART

Various peelers for the manual peeling and portioning of foodstuffs such as fruit and vegetables are known from the prior art, where in each case only the outermost skin is to be removed in the thinnest possible layer. The most economical possible peeling with the smallest possible production of waste should be achieved. The present-day peelers usually have a pendulum blade whose running direction is disposed differently relative to a grip longitudinal axis, whereby the skin of vegetables and fruit of various kinds, for example, potatoes, cucumbers, tomatoes, peppers, asparagus, carrots or apples, pears and kiwis can be removed in thin strips.

Depending on the product to be cut or peeled, the alignment of the running direction of the pendulum blade relative to the grip longitudinal axis can play a role and a better peeling result or an improved handling can be achieved. The pendulum blade must be able to track as simply as possible the outer shape of the product to be peeled, which can be achieved by different means. Depending on the penchant of the user, different orientations of the running direction of the pendulum blade can be favoured.

Known from DE202004012171 is a peeler having a blade holder with suspendable pendulum blade, where a blade running direction relative to a grip longitudinal axis of a handle is adjustable at two different angles. In this case, the pendulum blade can be aligned in a solid angle of 0° and a solid angle of 90° relative to the grip longitudinal axis.

The different alignments of the blade running direction with respect to the grip longitudinal axis are adjustable according to the applicant and penchant of the user. Whereas rounded vegetables and fruit can advantageously be peeled at an angle of 0°, the peel of elongate foodstuffs can usually be removed simply when the blade running direction is at an angle of 90° to the grip longitudinal axis. DE202004012171 provides a peeler which combines two previously known peelers in one. However, users desire more than two different possibilities for adjustment of the angle between blade running direction of the pendulum blade and the grip longitudinal axis of the handle, which cannot be solved with DE202004012171. The adjustment of the blade running direction is achieved by a pivoting movement of the blade holder about an axis of rotation, which only allows two states in which the blade running direction comes to rest in the plane of the grip longitudinal axis.

Known from US2005/0217122 is a peeler which allows a variable rotation of a blade holder together with pivotable pendulum blade relative to a grip longitudinal axis. The structure resembles a wet shaver, where the blade holder has a y-shaped or fork-shaped configuration and has a turning mandrel. This turning mandrel is guided through an eye on the grip and is there held twistably on the head region of the grip by a rotating knob which comprises spreading means. The pendulum blade together with blade holders can be locked in different positions on an axis which lies at a solid angle relative to the grip longitudinal axis.

This structure is technically very complex or cumbersome, where the blade holder, the rotating knob and the grip eye are completely separable from one another. Accordingly, the rotating knob could get lost during operation. Although the blade holder allows different positions, the adjustability cannot yet be achieved as desired. In order to achieve a rotatability of the pendulum blade, the head region of the grip must be aligned pointing away from the grip longitudinal axis, which results in the chunky and awkward appearance. The blade holder of US2005/0217122 can certainly be locked in various positions but, for example cannot be aligned relative to the grip longitudinal axis in such a manner that the blade running direction lies precisely in the straight extension of the grip longitudinal axis.

### SUMMARY OF THE DISCLOSURE

One aspect of the disclosure relates to a peeler that can be used flexibly and converted versatilely so that various types of vegetables and fruit can be optimally peeled according to the penchant of the user using a single peeler.

Further advantageous embodiments are also disclosed.

### BRIEF DESCRIPTION OF THE DRAWINGS

A preferred exemplary embodiment of the inventive subject matter is described hereinafter in connection with the appended drawings, where various possibilities for fastening the blade holder on the handle and shown and described.

FIG. 1A shows a schematic view of a peeler with a blade holder, where the set angle α between the blade pendulum axis and grip longitudinal axis is 90°,

FIG. 1B shows a view of the peeler according to FIG. 1A where the set angle α is 45° and

FIG. 1C shows a view of the peeler according to FIG. 1A where the set angle α is 0°.

FIGS. 2A and 2B show a partial section through a peeler according to FIGS. 1A-1C with a detailed view of the fastening of the blade holder on the grip head of the handle in a first embodiment.

FIGS. 3A and 3B show a partial section through a peeler according to FIGS. 1A-1C with a detailed view of the fastening of the blade holder on the grip head of the handle in a second embodiment.

### DESCRIPTION

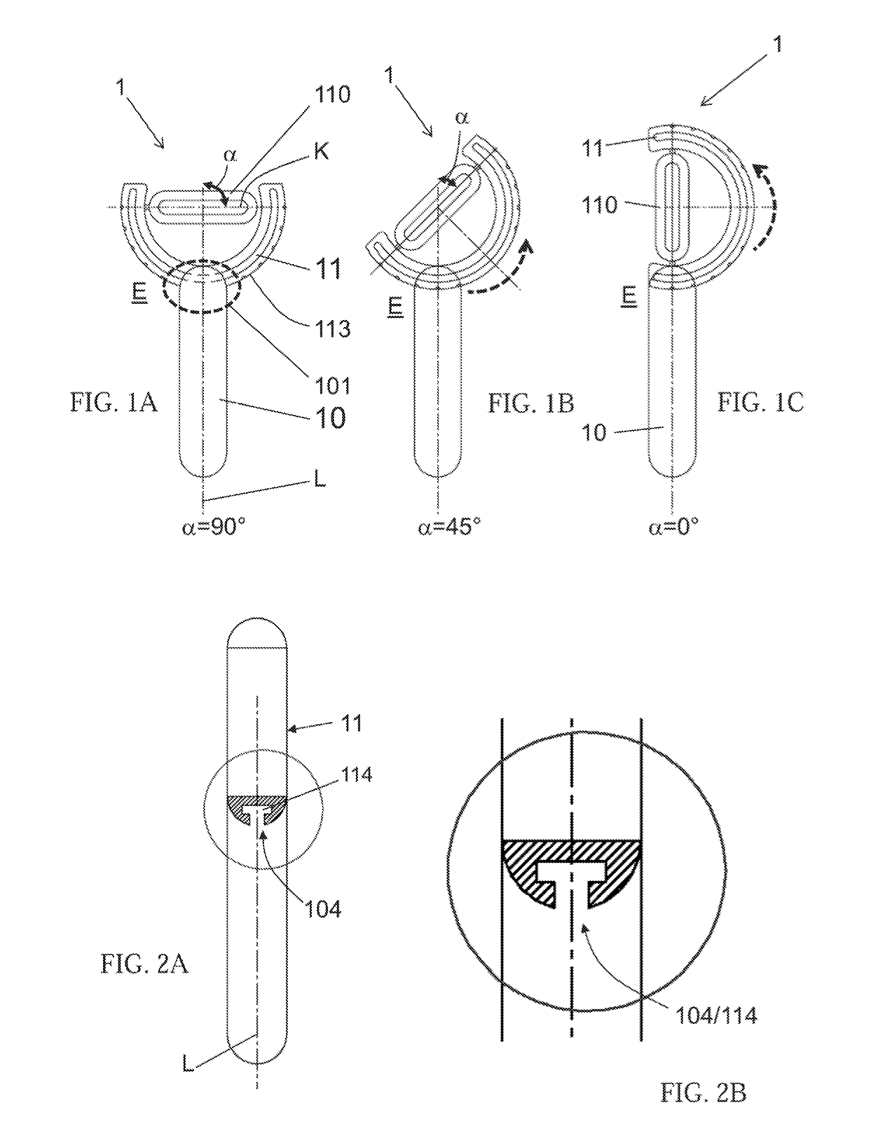

FIGS. 1A-1C show three different schematic views a), b) and c) of a peeler 1 with a handle 10 and a blade holder 11 disposed on a grip head 101 of the handle 10. The handle 10 has a grip longitudinal axis L and the blade holder 11 has a blade pendulum axis K in which a pendulum blade 110 is mounted rotatably or swingingly. An angle α between the blade pendulum axis K and the grip longitudinal axis can be adjusted smoothly.
In FIG. 1A the set angle α between the blade pendulum axis K and grip longitudinal axis L is 90°,
In FIG. 1B the set angle α between the blade pendulum axis K and grip longitudinal axis L is 45°, and
In FIG. 1C the set angle α between the blade pendulum axis K and grip longitudinal axis L is 0°.

The blade pendulum axis K and the grip longitudinal axis L here lie in a plane E or span the plane E which corresponds to the plane of the paper, where the blade holder 11 in this plane E is mounted rotatably about a pivot point in this plane E on the handle 10. Accordingly, a relative deflection of the blade holder 11 with respect to the grip longitudinal axis L and therefore to the handle 10 can be achieved. Preferably the axis of rotation runs through the plane E or the axis of rotation is perpendicular to the plane E.

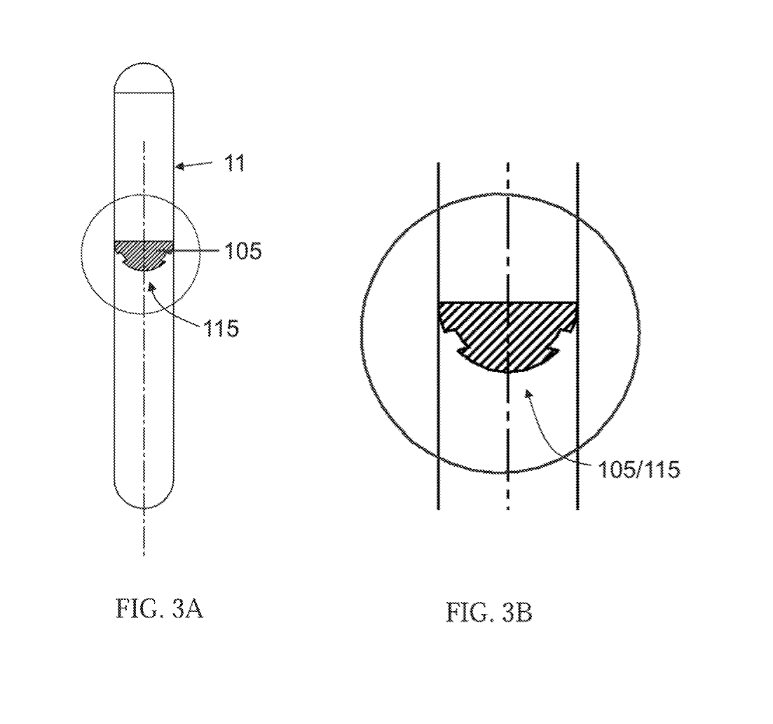

The blade holder 11 is configured to be substantially semi-circular and has a blade holder profile moulding disposed on the outer circumference 113 of the blade holder 11. Furthermore, a grip head profile moulding complementary to the blade holder profile moulding is provided on the grip head 101 of the handle 10. Both have a bent rail-like shape. The blade holder profile moulding and the grip head profile moulding are in this case complementary in such a manner that either the blade holder profile moulding is held undetachably in the grip head profile moulding or the grip head profile moulding is held undetachably in the blade holder profile moulding. Naturally various design possibilities are possible here. Two of these are explained in further detail in FIGS. 2A and 2B and FIGS. 3A and 3B. However, it is always the case that the blade holder profile moulding and the grip head profile moulding engage in one another mutually displaceably and positionably in order to achieve a multi-stage or smooth adjustability of the blade holder 11 on the handle 10 for adjustment of the angle α.

Undetachable, mutually supplementary or complementary rail-like profile mouldings of the said type are known per se. In the present case, it is obvious that the grip head profile moulding must have a curvature corresponding to the blade holder profile moulding.

By means of a suitable choice of production tolerances it can be achieved that a clearance fit is obtained between grip head profile moulding and the blade holder profile moulding such that the parts have little play and can still be displaced by hand force.

FIGS. 2A and 2B show a partial section through a peeler according to FIGS. 1A-1C with a detailed view of the fastening of the blade holder 11 on the grip head 101 of the handle 10 in a first embodiment.

In this embodiment the blade holder profile moulding on the blade holder 11 consists of a T groove 114 and the grip head profile moulding in the grip head (shaded area) accordingly has an undercut projection 104 in order to embrace the T shape and thus ensure the undetachability.

FIGS. 3A and 3B show a partial section through a peeler according to FIGS. 1A-1C with a detailed view of the fastening of the blade holder 11 on the grip head 101 of the handle 10 in a first embodiment.

In this embodiment the blade holder profile moulding consists of a swallowtail-like profile part 115 on the blade holder 11 and the grip head profile moulding consists of a swallowtail-like profile part 105 on the grip head (shaded area). Here also it would be possible to talk of two oblique grooves on the swallowtail-like profile part 105. The undetachability can also be ensured with such a shape.

As already implicitly mentioned, the depicted solutions are such that, for example, the T-groove 114 according to the embodiment of FIGS. 2A and 2B need not necessarily be on the blade holder 11 but could equally well also be attached to the grip head 101. Thus, the general formulation with the mutually complementary profile mouldings was also selected.

Additional fixing means can be provided which are used for engaging or clamping lockability of the blade holder (11) on the grip head (101). In the former case this can, for example, be snap-in cams and snap-in recesses which in FIGS. 1A to 1C are indicated as semicircles on the circumference of the blade holder 11. In the latter case, the fixing means can, for example, also be fixing screws or other clamping means acting on the clearance fit. With such means it can be prevented that the setting of the angle α is changed as a result of the play.

### REFERENCE LIST

1 Peeler
10 Handle
   101 Grip head
   104 Undercut projection
   105 Swallowtail-like profile part on grip head
   L Grip longitudinal axis (or direction)
11 Blade holder
   110 Pendulum blade
   113 Outer circumference (of blade holder)
   114 T-groove
   115 Swallowtail-like profile part on blade holder
   K Blade pendulum axis (or direction)
α Angle (between K and L)
E Plane

1. A peeler having a handle and a blade holder (disposed on the grip head of the handle with an adjustable pendulum blade, wherein the pendulum blade is disposed adjustably by an angle (between a blade pendulum axis direction and a grip longitudinal axis direction of the handle,
wherein
the blade holder is configured to be substantially semi-circular and is provided with a blade holder profile moulding disposed on the outer circumference of the blade holder and wherein a grip head profile moulding complementary to the blade holder profile moulding is provided on the grip head, in such a manner that the blade holder profile moulding and the grip head profile moulding engage displaceably and positionably in one another in order to achieve a smooth adjustability of the blade holder on the handle for adjustment of the angle.

2. The peeler according to claim 1, wherein the blade holder profile moulding or the grip head profile moulding are configured as a T groove and the grip head profile moulding or the blade holder profile moulding is configured as an undercut projection respectively on the blade holder or on the grip head.

3. The peeler according to claim 1, wherein the blade holder profile moulding and the grip head profile moulding are each configured as swallowtail-shaped.

4. The peeler according to claim 1, wherein additional fixing means are provided on the blade holder and the grip head for engaging and clamping lockability of the blade holder on the grip head.

5. The peeler according to claim 2, wherein additional fixing means are provided on the blade holder and the grip head for engaging and clamping lockability of the blade holder on the grip head.

6. The peeler according to claim 3, wherein additional fixing means are provided on the blade holder and the grip head for engaging and clamping lockability of the blade holder on the grip head.

7. The peeler according to claim 1, wherein the blade pendulum axis and the grip longitudinal axis span a plane in which the pivot point lies, about which the relative rotation of the blade holder to the handle can be executed.

8. The peeler according to claim 2, wherein the blade pendulum axis and the grip longitudinal axis span a plane in which the pivot point lies, about which the relative rotation of the blade holder to the handle can be executed.

9. The peeler according to claim 3, wherein the blade pendulum axis and the grip longitudinal axis span a plane in which the pivot point lies, about which the relative rotation of the blade holder to the handle can be executed.

10. The peeler according to claim 4, wherein the blade pendulum axis and the grip longitudinal axis span a plane in which the pivot point lies, about which the relative rotation of the blade holder to the handle can be executed.

11. The peeler according to claim 5, wherein the blade pendulum axis and the grip longitudinal axis span a plane in which the pivot point lies, about which the relative rotation of the blade holder to the handle can be executed.

12. The peeler according to claim 6, wherein the blade pendulum axis and the grip longitudinal axis span a plane in which the pivot point lies, about which the relative rotation of the blade holder to the handle can be executed.
